(19) United States
(12) Patent Application Publication
(10) Pub. No.: US 2026/0166605 A1
(43) Pub. Date: Jun. 18, 2026

(54) MULTI-FORM DECOMPOSITION

(71) Applicant: Josh Hershman, Guilford, CT (US)

(72) Inventor: Josh Hershman, Guilford, CT (US)

(21) Appl. No.: 18/986,634

(22) Filed: Dec. 18, 2024

(51) Int. Cl. B09B 3/60; C05F 9/00; C05F 17/20

(52) U.S. Cl. CPC B09B 3/60; C05F 9/00; C05F 17/20

(57) ABSTRACT

The present invention provides a decomposition acceleration composition designed to enhance the aerobic decomposition of waste in household trash and similar cross over commercial applications. The product contains a blend of enzymes, microbial inoculants, nutrients, and other agents that, upon activation by moisture, accelerate the breakdown of waste. This accelerates the methane gas release and ultimately reduces volume of waste entering anaerobic decomposition phases in landfills, thereby lowering methane emissions.

### BACKGROUND

The challenge of waste management dates back to ancient civilizations, where rudimentary methods such as burying, burning, and dumping waste were employed to manage refuse. While effective on a small scale, these methods had severe environmental and public health consequences, including groundwater contamination, air pollution, and disease outbreaks. As urbanization grew during the industrial revolution, the need for systematic waste management became apparent.

The mid-20th century saw the establishment of sanitary landfills, designed to contain waste and minimize environmental harm. These facilities involved engineered liners and leachate collection systems to prevent groundwater contamination. However, landfills unintentionally became significant sources of methane gas, a potent greenhouse gas, due to anaerobic decomposition of organic matter in the absence of oxygen.

Landfills account for a substantial portion of global methane emissions, contributing significantly to climate change. Methane has a warming potential over 25 times greater than carbon dioxide over a 100-year period. Despite efforts to capture and utilize landfill gas for energy, the process remains inefficient, with a significant percentage of methane escaping into the atmosphere. This issue highlights the need to tackle methane production at its source—by enhancing aerobic decomposition of waste before it reaches anaerobic landfill conditions.

Technological advancements in waste management have focused on recycling, composting, and anaerobic digestion. While composting accelerates the decomposition of organic matter in controlled aerobic conditions, its adoption in households and small-scale settings remains limited due to the complexity of the process. Similarly, anaerobic digestion technologies, while effective in industrial settings, are not practical for everyday household use. Thus, there exists a gap in the market for accessible, user-friendly solutions to reduce methane emissions and enhance decomposition at the source.

Over the years, researchers have explored methods to accelerate organic waste decomposition using microbial inoculants and enzymes. These agents, when introduced to waste, break down complex organic materials into simpler compounds, speeding up the decomposition process. However, the majority of these innovations have been limited to agricultural or industrial applications, with little focus on household and light commercial use. Moreover, many existing solutions are targeted at composting rather than addressing waste that ultimately ends up in landfills.

Households generate significant amounts of organic waste, much of which is disposed of in traditional trash bags and sent to landfills. Without intervention, this waste undergoes slow anaerobic decomposition, contributing to methane emissions. Traditional waste management practices lack a simple, effective, and scalable solution for households to address this issue, creating a pressing need for innovations that bridge this gap.

The present invention represents a pivotal advancement in waste management by providing a user-friendly solution designed specifically for households and light commercial settings. Unlike traditional methods, this invention combines convenience, versatility, and effectiveness by offering decomposition accelerators in multiple forms, tablets, sprays, and trash bags embedded with decomposition agents.

This invention aligns with global efforts to combat climate change by addressing a major source of greenhouse gas emissions. By empowering individuals and small businesses to actively participate in waste decomposition, it fosters widespread adoption of sustainable practices. The innovation not only reduces methane production but also supports circular waste systems by producing compost-like byproducts that can be utilized as soil enhancers.

The introduction of this decomposition accelerator sets the stage for further advancements in household waste management technologies. As awareness of climate change grows, innovations like this are crucial in creating accessible and scalable solutions for sustainable waste disposal. The combination of ease of use, scientific effectiveness, and environmental benefits positions this invention as a cornerstone in the evolution of waste management practices.

### BRIEF DESCRIPTION OF THE DRAWINGS

FIG. 1 shows the spray bottle which may use with the liquid solution for decomposition.

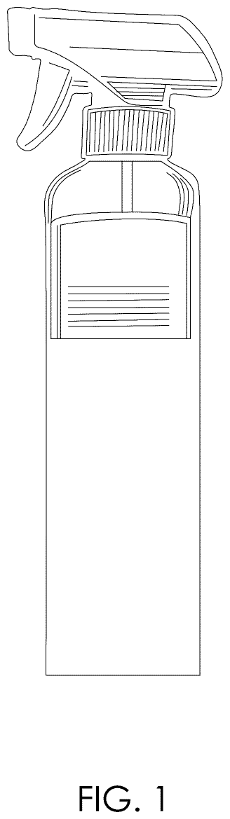

FIG. 2 shows the bag with signs of decomposition.

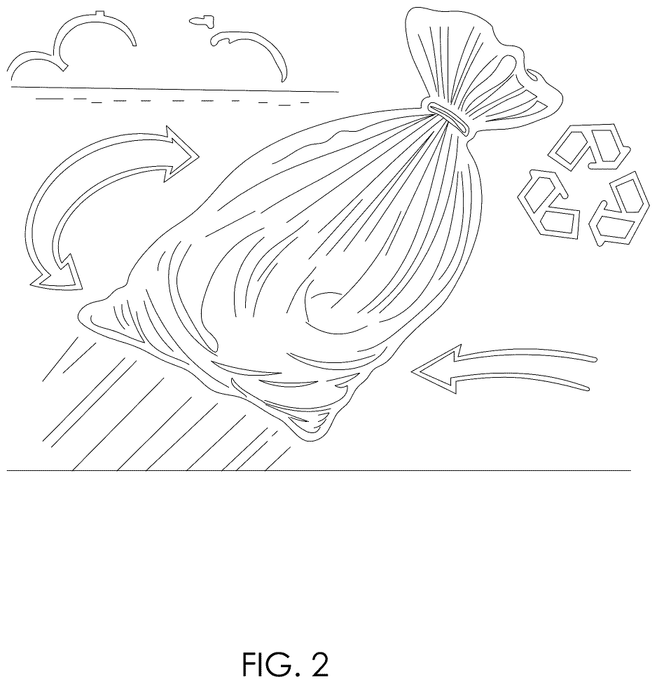

FIG. 3 shows the tablets for decomposition.

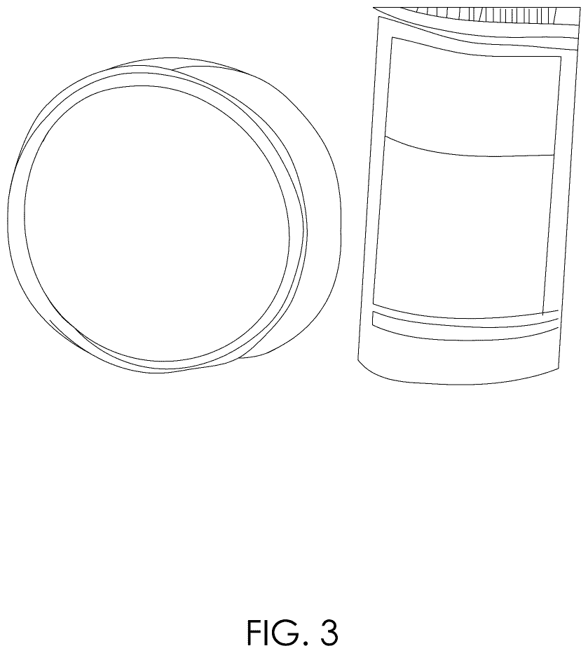

### DETAILED DESCRIPTION

This invention introduces a highly advanced system for accelerating the decomposition of waste in household and light commercial settings, specifically designed to address the environmental challenge of methane emissions from landfills. The product enhances aerobic decomposition through a scientifically optimized composition comprising enzymes, microbial inoculants, essential nutrients, and additional agents. The enzymes proteases, cellulases, amylases, and others catalyze the breakdown of complex organic compounds such as proteins, cellulose, and starches into simpler substances. These enzymes work in synergy with microbial inoculants, including selected strains of bacteria and fungi like Bacillus, Pseudomonas, Trichoderma, and Aspergillus, which are known for their efficiency in aerobic degradation. To support microbial growth and sustain the decomposition process, the product incorporates nutrient sources such as nitrogen, phosphorus, potassium, and micronutrients. A biodegradable binder, made from materials like polyvinyl alcohol or starch-based compounds, ensures the product maintains its integrity during storage and handling while dissolving upon contact with moisture. Additional agents such as surfactants, pH buffers, chelating agents, and moisture-retaining compounds enhance the efficiency of the decomposition process by optimizing the conditions under which the microbes and enzymes operate.

The invention's mechanism of action begins when moisture activates the product, dissolving the biodegradable binder to release the active components into the waste. Enzymes immediately start breaking down complex organic molecules into simpler compounds, which are then rapidly consumed and degraded by the microbial inoculants. This carefully coordinated process ensures aerobic decomposition, drastically reducing the volume of organic waste subject to anaerobic conditions, which are the primary source of methane emissions. The product is engineered for maximum convenience and is available in three formats: tablets, sprays, and trash bags embedded with decomposition agents as well as similar other deployment methods. The tablet form is designed for placement directly into household or commercial trash bags, where it activates in the presence of slight moisture. The spray form provides a flexible application option, allowing users to target specific areas of waste for accelerated decomposition. The trash bags, pre-embedded with decomposition agents, offer a hands-free solution that activates automatically upon exposure to moisture from waste materials.

This invention offers numerous advantages that make it a groundbreaking contribution to sustainable waste management. It significantly reduces decomposition time, making organic waste breakdown faster and more efficient. By fostering aerobic decomposition, the product mitigates methane emissions, which are major contributor to climate change. Its user-friendly design allows for seamless integration into standard waste management practices, enabling households and small businesses to adopt the solution with minimal effort. The invention is also cost-effective, as it leverages biodegradable materials and eco-friendly components, contributing positively to environmental sustainability. Additionally, the accelerated decomposition process reduces the volume of waste in landfills, extending their operational lifespan and delaying the need for new landfill sites. Beyond reducing methane emissions, the decomposed material can be repurposed as nutrient-rich compost, offering a natural alternative to chemical fertilizers and enhancing soil health.

Preliminary experimental validation underscores the effectiveness of this invention. A comparative study was conducted using a control group of untreated waste bags and a treated group with the decomposition accelerator. Both groups were subjected to identical conditions, including sunlight exposure and initial water addition, over a two-week period. The results revealed significantly faster decomposition in the treated group, validating the product's ability to enhance aerobic processes and reduce methane emissions. By accelerating decomposition and lowering greenhouse gas emissions, this invention aligns with global efforts to combat climate change while addressing critical waste management challenges. Its practical design, coupled with its environmental benefits, ensures it is a scalable and impactful solution for households, municipalities, and small businesses alike.

The present invention presents an innovative solution for accelerating waste decomposition, designed to address critical challenges in waste management, including the reduction of methane emissions and the stabilization of organic material before reaching anaerobic decomposition phases in landfills. The invention utilizes a scientifically developed blend of enzymes, microbial inoculants, and supporting agents, delivered in user-friendly formats such as tablets, sprays, and embedded trash bags. The core mechanism enhances aerobic microbial activity to decompose organic waste more rapidly, reducing environmental impacts and enabling more efficient waste processing.

Experimental results underscore the effectiveness of this technology. Treated waste demonstrated a 10% reduction in weight compared to a 5% reduction in the control group (post water liquid run off varies based on percent of organic waste compared to inorganic waste in the treated waste), highlighting the accelerated decomposition achieved with the product. The treated samples reached significant decomposition within one week, while the control group showed minimal progress in the same timeframe. This rapid breakdown not only reduces the volume of waste destined for landfills but also enhances stabilization, preventing prolonged anaerobic methane gas.

Interestingly, preliminary methane emission measurements from treated waste revealed an initial increase in emissions due to the faster aerobic microbial activity. This controlled release contrasts with the slower buildup typically seen in untreated waste, ultimately reducing long-term methane emissions. By facilitating faster stabilization of waste, the invention mitigates one of the largest contributors to greenhouse gas emissions from landfills.

In addition to the decomposition benefits, water test results provided further insights into the chemical transformations induced by the tablets. The test waste showed zero levels of nitrates and nitrites compared to 10 ppm and 1 ppm in the control, respectively, indicating a more complete breakdown of nitrogen compounds. Other parameters, including total hardness and free chlorine, were also significantly reduced in the treated samples. However, elevated levels of iron (5 ppm) and lead (50 ppm) in the test waste compared to the control (2 ppm and 20 ppm, respectively) suggest the mobilization or transformation of these elements during accelerated decomposition. The pH of the test waste increased slightly to 6.8 compared to 6.4 in the control, reflecting chemical changes associated with rapid organic matter degradation. This finding varies based on the percent of organic verse inorganic material in the trash bag.

These findings demonstrate that the decomposition acceleration products not only enhance the rate of waste breakdown but also alter its chemical profile, leading to a more efficient decomposition process. The combination of reduced waste volume, faster stabilization, and minimized methane production positions this invention as a transformative technology for waste management. Furthermore, the ability to influence the chemical dynamics of decomposing waste, as evidenced by water test results, suggests broader applications in environmental sustainability and resource recovery.

The composition is comprising of;
Enzymes: A combination of proteases, cellulases, amylases, and other enzymes catalyzing the breakdown of proteins, cellulose, starches, and other compounds.
Microbial Inoculants: Specific strains of bacteria, fungi, and other microorganisms for efficient aerobic decomposition, including Bacillus spp., Pseudomonas spp., Trichoderma spp., and Aspergillus spp.
Nutrient Sources: Essential nutrients like nitrogen, phosphorus, potassium, and micronutrients supporting microbial growth and activity.
Binder: A biodegradable binder such as polyvinyl alcohol or starch-based materials, maintaining the product's integrity until use.
Additional Agents: Surfactants, chelating agents, pH buffers, and moisture-retaining compounds enhancing decomposition.

In conclusion, this invention provides a cost-effective, scalable, and environmentally beneficial solution to waste decomposition challenges. By integrating advanced biochemical mechanisms with practical delivery formats, it empowers households, businesses, and municipalities to adopt more sustainable waste management practices. This innovation aligns with global efforts to mitigate climate change and optimize landfill operations, offering a significant reduction in methane emissions, improved decomposition efficiency, and potential applications in producing nutrient-rich compost for agricultural use.

1. A decomposition acceleration composition comprising:
A blend of enzymes, including but not limited to proteases, cellulases, and amylases.
Microbial inoculants, including but not limited to strains of bacteria and fungi.
Nutrient sources to support microbial growth.
A biodegradable binder.
Additional agents to enhance decomposition.

2. The decomposition acceleration composition of claim 1, wherein the composition is activated by moisture.

3. The decomposition acceleration composition of claim 1, wherein the microbial inoculants are selected from strains known for aerobic decomposition of organic matter, including but not limited to Bacillus, Pseudomonas, Trichoderma, and Aspergillus.

4. The decomposition acceleration composition of claim 1, wherein the product reduces the volume of waste entering anaerobic decomposition phases in landfills, thereby reducing methane emissions.

5. The decomposition acceleration composition of claim 1, wherein the additional agents include surfactants, chelating agents, pH buffers, and moisture-retaining compounds to optimize the decomposition process.

6. A method for accelerating the decomposition of waste in household and other light commercial trash, comprising:
Placing a decomposition acceleration product in a household trash bag containing waste.
Ensuring the waste is slightly moist to activate the product.
Disposing of the trash bag as usual, allowing the product to accelerate the decomposition process.

7. The decomposition acceleration composition of claim 1, wherein the enzymes, microbial inoculants, nutrient sources, binder, and additional agents are present in amounts sufficient to significantly accelerate the decomposition process of waste.

8. The decomposition acceleration composition of claim 1, wherein the accelerated decomposition process leads to a reduction in methane gas emissions.

9. A method for mitigating climate change by reducing methane emissions, comprising:
Utilizing the decomposition acceleration composition of claim 1 in household waste management.
Enhancing the aerobic decomposition of waste to reduce the production of methane gas, a potent greenhouse gas.

9. The decomposition acceleration composition of claim 1, wherein the composition is provided in multiple forms, including:
Tablet form for placement in waste containers;
Spray form for direct application onto waste;
Trash bags embedded with the decomposition agents for automated activation.

10. The decomposition acceleration composition of claim 1, wherein the binder is selected from biodegradable materials such as polyvinyl alcohol, starch-based compounds, or similar environmentally friendly substances.

11. The decomposition acceleration composition of claim 1, wherein the enzymes and microbial inoculants are encapsulated to ensure stability during storage and controlled release during activation.

12. A method for producing nutrient-rich compost from waste, comprising:
Applying the decomposition acceleration composition of claim 1 to organic waste;
Facilitating aerobic decomposition to break down the waste into simpler compounds;
Collecting the decomposed material as compost suitable for agricultural use.

13. The decomposition acceleration composition of claim 1, wherein the composition reduces the weight of waste by approximately 10% varying based on percent of organic waste to inorganic waste in the trash bag within a one-week period under controlled conditions.

14. A method for reducing the chemical contamination in decomposing waste, comprising:
Applying the decomposition acceleration composition of claim 1 to waste materials;
Facilitating the transformation of nitrogen compounds, chlorine, and other inorganic elements into stable or less harmful forms during decomposition.

15. The decomposition acceleration composition of claim 1, wherein the water test results demonstrate a reduction in nitrate and nitrite levels compared to untreated waste, varying based on percent of organic verses inorganic waste in the trash bag.

16. The decomposition acceleration composition of claim 1, wherein the elevated levels of iron and lead released during decomposition are monitored and stabilized to prevent environmental contamination.

17. A system for waste decomposition, comprising:
A composition as described in claim 1;
A delivery mechanism for activating the composition, including pre-embedded trash bags, tablets, or sprays;
A monitoring system to measure the decomposition rate and emissions, ensuring regulatory compliance.

18. The decomposition acceleration composition of claim 1, wherein the pH of decomposing waste is adjusted to a range of 6.5-7.5, promoting optimal microbial activity.

19. The decomposition acceleration composition of claim 1, wherein it is formulated to prevent long-term methane buildup by accelerating early-stage aerobic microbial activity.

20. A method for mitigating environmental pollution from landfills, comprising:
Utilizing the decomposition acceleration composition of claim 1 in waste management systems;
Enhancing the breakdown of organic and inorganic compounds to minimize toxic leachates and emissions.
